(19) United States
(12) Patent Application Publication
(10) Pub. No.: US 2026/0329990 A1
(43) Pub. Date: Oct. 22, 2026

(54) SECURE ELEMENT AND USER AUTHENTICATION METHOD

(71) Applicant: TOYOTA JIDOSHA KABUSHIKI KAISHA, Aichi-ken (JP)

(72) Inventor: Michael PADDON, Shinjuku-ku (JP)

(21) Appl. No.: 19/642,630

(22) Filed: Apr. 9, 2026

(30) Foreign Application Priority Data
Apr. 21, 2025 (JP) 2025-069407

(51) Int. Cl. G06F 21/31

(52) U.S. Cl. CPC G06F 21/316

(57) ABSTRACT

A secure element with an application installed is provided. The secure element includes: a processor configured to execute the application; a memory configured to store registration action information indicating a content of a registration action associated with a user of the secure element; and a sensor configured to detect a change in the secure element caused by a physical action given to the secure element. The processor recognizes a physical action given to the secure element based on a result of detection by the sensor. When the recognized physical action matches the registration action, the processor allows providing the user with a function of the application. When the recognized physical action does not match the registration action, the processor prohibits providing the user with the function of the application.

### CROSS-REFERENCES TO RELATED APPLICATION

The present disclosure claims priority to Japanese Patent Application No. 2025-069407, filed on Apr. 21, 2025, the contents of which application are incorporated herein by reference in their entirety.

### TECHNICAL FIELD

The present disclosure relates to a user authentication technique applied to a secure element.

### BACKGROUND ART

Patent Literature 1 discloses a digital key method for enabling a digital key service.

Patent Literature 2 discloses a gesture recognition method for recognizing a human gesture.

### LIST OF RELATED ART

Patent Literature 1: Japanese U.S. Pat. No. 7,350,128

Patent Literature 2: U.S. Pat. No. 9,746,929

### SUMMARY

A secure element is a tamper-resistant portable device. The secure element with an application installed can provide a user of the secure element with a function of the application. Here, it is preferable to authenticate the user of the secure element before providing the function of the application. That is, it is preferable to confirm whether or not the user of the secure element is a valid user before providing the function of the application. Regarding the user authentication applied to the secure element, there is room for improvement in security and reliability.

An object of the present disclosure is to provide a new user authentication technique applied to a secure element.

A first aspect relates to a secure element with an application installed.

The secure element includes:
a processor configured to execute the application;
a memory configured to store registration action information indicating a content of a registration action associated with a user of the secure element; and
a sensor configured to detect a change in the secure element caused by a physical action given to the secure element.

The processor recognizes a physical action given to the secure element based on a result of detection by the sensor. When the recognized physical action matches the registration action, the processor allows providing the user with a function of the application. When the recognized physical action does not match the registration action, the processor prohibits providing the user with the function of the application.

A second aspect relates to a user authentication method executed by a secure element with an application installed.

The secure element includes:
a memory configured to store registration action information indicating a content of a registration action associated with a user of the secure element; and
a sensor configured to detect a change in the secure element caused by a physical action given to the secure element.

The user authentication method includes:
recognizing a physical action given to the secure element based on a result of detection by the sensor;
when the recognized physical action matches the registration action, allowing providing the user with a function of the application; and
when the recognized physical action does not match the registration action, prohibiting providing the user with the function of the application.

According to the present disclosure, the user authentication is performed based on the physical action given to the secure element. More specifically, the secure element has the sensor for detecting a change in the secure element caused by the physical action applied to the secure element. Based on a result of the detection by the sensor, it is possible to recognize the physical action given to the secure element. Meanwhile, the registration action associated with the user is registered in advance in the secure element. When the recognized physical action matches the registration action, it is allowed to provide the user with the function of the application installed on the secure element.

As described above, according to the present disclosure, it is possible to perform the user authentication without using a terminal device other than the secure element. In other words, it is possible to perform the user authentication without depending on security of the terminal device other than the secure element. Furthermore, an attacker is unable to access information of the registration action registered in the secure element. Therefore, the user authentication with high security is realized.

### BRIEF DESCRIPTION OF DRAWINGS

FIG. 1 is a conceptual diagram for explaining an overview of a secure element;

FIG. 2 is a conceptual diagram for explaining action-based user authentication.

FIG. 3 is a block diagram showing an example of a configuration of a secure element;

FIG. 4 is a flowchart showing an action registration process;

FIG. 5 is a flowchart showing a user authentication process; and

FIG. 6 is a conceptual diagram for explaining a modification example.

### DETAILED DESCRIPTION

Embodiments of the present disclosure will be described with reference to the accompanying drawings.

### 1. Secure Element

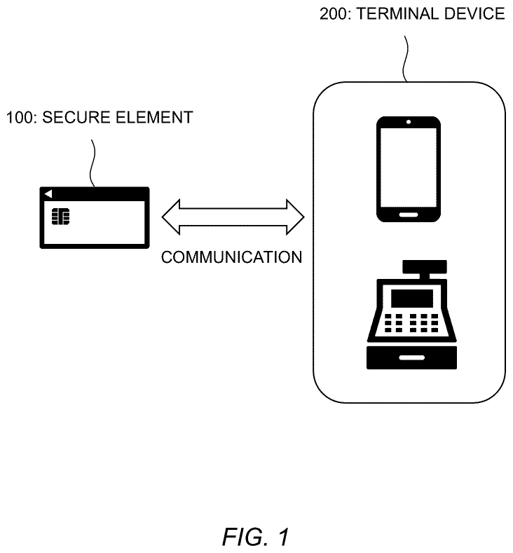

FIG. 1 is a conceptual diagram for explaining an overview of a secure element (SE) 100. The secure element 100 is a device having an information processing capability, a memory capability, and a communication capability. In particular, the secure element 100 is a tamper-resistant portable device. For example, the secure element 100 is used for storing important information such as a secret key, a digital certificate, confidential information, authentication information, personal information, and the like. For example, the secure element 100 is a card-type medium provided with an integrated circuit (IC) chip. The secure element 100 may be a smart card. The secure element 100 may be a Universal Integrated Circuit Card (UICC).

The secure element 100 is capable of communicating with a terminal device 200. Examples of the terminal device 200 include a smartphone, a tablet, a reading device (reader), personal computer, and the like. Typically, the terminal device 200 includes a user interface for receiving an input from a user. A communication method may be a non-contact communication method or a contact communication method. The non-contact communication method may be a near field communication (NFC) method. Examples of the communication standard include ISO 14443 (NFC) and ISO 7816 (contact interface).

An application is installed in the secure element 100. The application is also referred to as an applet. The secure element 100 with the application installed can provide a user of the secure element 100 with a function of the application. Examples of the function of the application include payment, settlement, authentication, and the like. The function of the application is achieved based on the important information stored in the secure element 100.

The user of the secure element 100 can use the function of the application installed in the secure element 100. For example, the user operates the secure element 100 so that a communication between the secure element 100 and the terminal device 200 is established. For example, the user holds the secure element 100 over a reading unit of the terminal device 200. The application of the secure element 100 and the terminal device 200 communicate with each other. The terminal device 200 reads out the important information stored in the secure element 100, and executes processing related to the function of the application based on the read information.

However, it is preferable to authenticate the user of the secure element 100 before providing the function of the application. That is, it is preferable to confirm whether or not the user of the secure element 100 is a valid user before providing the function of the application.

As one comparative example, user authentication using a personal identification number (PIN) is considered here. The user enters a PIN to the terminal device 200. The PIN entered by the user is sent from the terminal device 200 to the secure element 100. The secure element 100 performs the user authentication based on the entered PIN. However, the method according to the comparative example depends on security and reliability of the terminal device 200. If the security or reliability of the terminal device 200 is low, the PIN entered by the user is at risk. This is not preferable. As another example, placing a capacitive keyboard on a housing of the secure element 100 is not practical in view of the size and shape of the secure element 100.

As described above, regarding the user authentication applied to the secure element 100, there is room for improvement in security and reliability. In view of the above, the present embodiment provides a new user authentication technique based on another approach.

### 2. Action-Based User Authentication

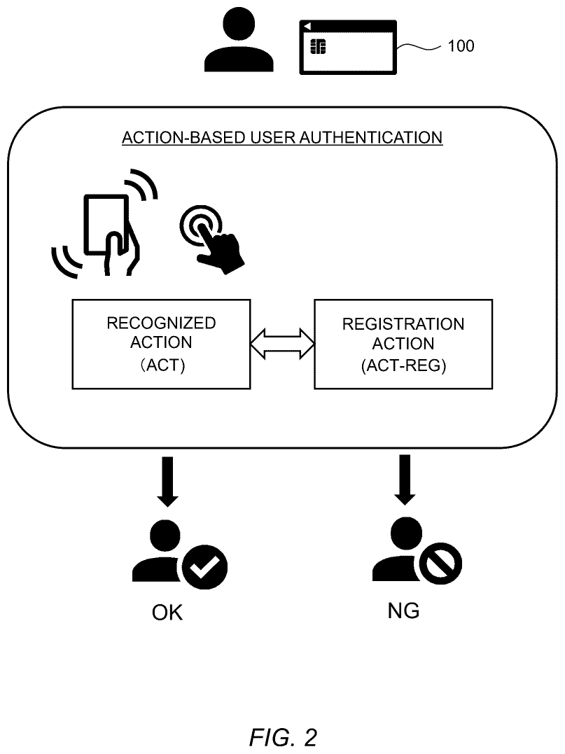

According to the present embodiment, the user authentication is performed based on a physical action given to the secure element 100 by the user. This is hereinafter referred to as “action-based user authentication”. FIG. 2 is a conceptual diagram for explaining the action-based user authentication according to the present embodiment.

The user directly or indirectly gives a physical action of a predetermined pattern to the secure element 100. For example, the user holding the secure element 100 in the user's hand may move the user's hand in a predetermined pattern. That is, the physical action of the user may be a gesture of the user holding the secure element 100 in the user's hand. As another example, the user may tap the secure element 100 in a predetermined pattern. That is, the physical action of the user may be tapping the secure element 100 in a predetermined pattern. When the secure element 100 and the terminal device 200 are in contact with each other, it is also possible to indirectly tap the secure element 100 by tapping the terminal device 200. That is, the user may indirectly give the physical action to the secure element 100. It should be noted that an action that is too simple is not preferable for the physical action, and an action that continues for a certain period of time or longer is preferable for the physical action. The physical action may consist of multiple repetitions of the same pattern. The physical action may be a combination of a gesture and a tap.

The secure element 100 is equipped with a sensor for recognizing the physical action of the user. The secure element 100 (the application) uses the sensor to recognize the physical action given to the secure element 100. The physical action recognized using the sensor is hereinafter referred to as a “recognized action ACT”.

Meanwhile, a registration action ACT-REG associated with a valid user is registered in advance in the secure element 100. The secure element 100 (the application) compares the recognized action ACT with the registration action ACT-REG. When the recognized action ACT matches the registration action ACT-REG, the secure element 100 (the application) determines that the user authentication result is “OK”, and allows providing the user with the function of the application. On the other hand, when the recognized action ACT does not match the registration action ACT-REG, the secure element 100 (the application) determines that the user authentication result is “NG”, and prohibits providing the user with the function of the application.

As described above, according to the present embodiment, the user authentication is performed based on the physical action given to the secure element 100. That is, it is possible to perform the user authentication without using the terminal device 200 other than the secure element 100. In other words, it is possible to perform the user authentication without depending on security of the terminal device 200 other than the secure element 100. Furthermore, an attacker is unable to access the information of the registration action ACT-REG registered in the secure element 100. Therefore, the user authentication with high security is realized.

### 3. Configuration Example of Secure Element

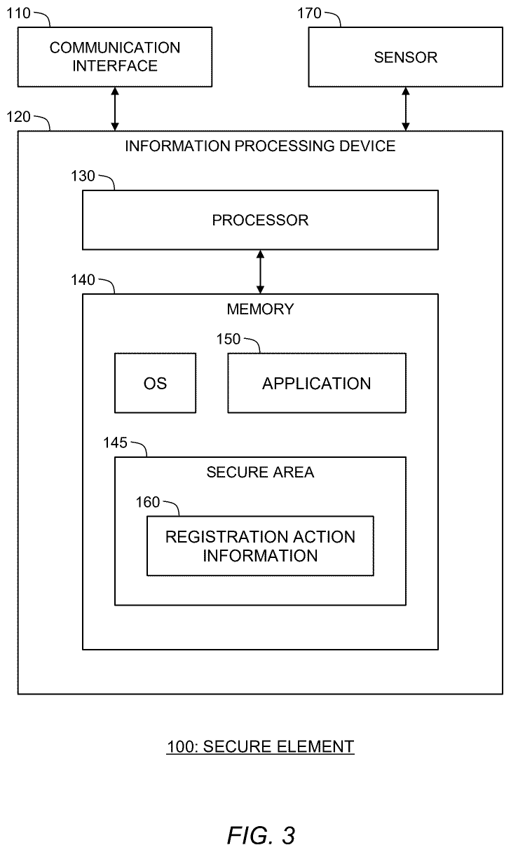

FIG. 3 is a block diagram illustrating an example of a configuration of the secure element 100 according to the present embodiment.

The secure element 100 includes a communication interface 110 for communicating with the terminal device 200. The communication interface may be a non-contact communication interface or a contact communication interface.

The secure element 100 further includes an information processing device 120 that executes a variety of processing. The information processing device 120 includes one or more processors 130 and one or more memories 140. The processor 130 executes a variety of processing. Examples of the processor 130 include a general-purpose processor, a special-purpose processor, a central processing unit (CPU), an application specific integrated circuit (ASIC), a field-programmable gate array (FPGA), an integrated circuit, and the like. The processor 130 may also be referred to as processing circuitry. The memory 140 stores a variety of information. Examples of the memory 140 include a volatile memory, a nonvolatile memory, a hard disk drive (HDD), a solid state drive (SSD), and the like.

The memory 140 stores computer programs such as an operating system (OS), an application 150, and the like. The application 150 provides the function such as payment, settlement, authentication, and the like. The processor 130 executes the computer programs such as the OS and the application 150.

The memory 140 includes a secure area 145. The secure area 145 is used for storing important information such as a secret key, a digital certificate, confidential information, authentication information, personal information, and the like. In addition, registration action information 160 indicating the content of the registration action ACT-REG associated with the user is stored in the secure area 145.

The secure element 100 further includes a sensor 170 used for recognizing a physical action of the user. More specifically, the sensor 170 detects a change in the secure element 100 caused by the physical action given to the secure element 100. For example, the sensor 170 may include a motion sensor that detects movement of the secure element 100. The movement of the secure element 100 may be one dimensional, two dimensional, or three dimensional. As another example, the sensor 170 may include a vibration sensor that detects vibration of the secure element 100 (i.e., impact given to the secure element 100). As yet another example, the sensor 170 may include a touch sensor that detects contact with the secure element 100. The sensor 170 may include a combination of these. For example, the sensor 170 includes a micro electro mechanical systems (MEMS) acceleration sensor. The MEMS acceleration sensor can detect acceleration, inclination, movement, vibration, impact, and the like.

The processor 130 receives a result of detection by the sensor 170. Then, the processor 130 recognizes a physical action given to the secure element 100 on the basis of the result of detection by the sensor 170. For example, the physical action of the user is a gesture of the user holding the secure element 100 in the user's hand. Such a gesture of the user can be recognized based on the result of detection by the motion sensor. As another example, the physical action of the user may be tapping the secure element 100. Such a tap by the user can be recognized based on the result of detection by the vibration sensor or the touch sensor.

For example, the sensor 170 is the MEMS acceleration sensor. The MEMS acceleration sensor operates in one or more axes. The processor 130 receives the result of detection by the MEMS acceleration sensor. The processor 130 recognizes action components of the user by analyzing the result of detection by the MEMS acceleration sensor. Further, the processor 130 recognizes the physical action of the user by integrating a series of action components. For example, the gesture recognition technique described in the above-mentioned Patent Literature 2 (U.S. Pat. No. 9,746,929) can be utilized.

The physical action of the user recognized using the sensor 170 (i.e., the recognized action ACT) may be reduced to a signature. By using the signature, it is possible to easily determine whether two or more physical actions match or do not match.

### 4. Processing Flow

The processor 130 executes the application 150 and performs a variety of processing in accordance with instructions from the application 150. In the following description, the processor 130 is described as a processing subject, but the “processor 130” may be replaced by the “application 150”.

### 4-1. Action Registration Process

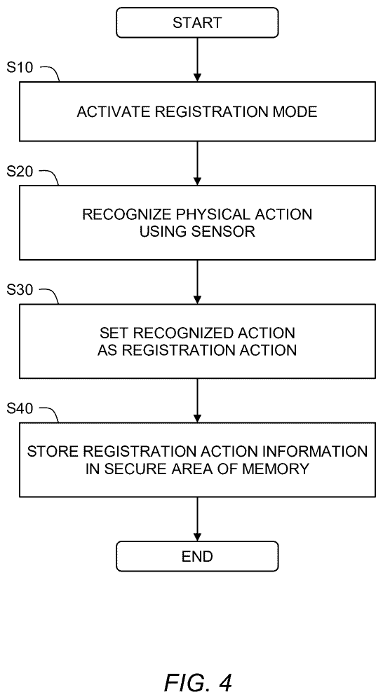

FIG. 4 is a flowchart showing a action registration process related to the registration of the registration action ACT-REG.

In Step S10, the processor 130 activates a registration mode. For example, in a state where the secure element 100 and the terminal device 200 are communicating with each other, the user enters a registration mode activation code in the terminal device 200. The registration mode activation code is specific to the application 150. For example, the registration mode activation code is a registration-specific PIN unique to the application 150. The registration mode activation code is sent from the terminal device 200 to the secure element 100. In response to the registration mode activation code, the processor 130 activates the registration mode.

When the registration mode is activated, the user performs a registration action ACT-REG which is a physical action that the user wants to register. That is, the user gives the registration action ACT-REG to the secure element 100.

In Step S20, the processor 130 recognizes the physical action by using the sensor 170. More specifically, the processor 130 receives a result of detection by the sensor 170. Then, the processor 130 recognizes the physical action given to the secure element 100 on the basis of the result of detection by the sensor 170. The recognized physical action is the recognized action ACT.

In Step S30, the processor 130 sets the recognized action ACT as the registration action ACT-REG.

For example, a predetermined entry time is given from the activation of the registration mode, and the user performs a physical action to be registered during the entry time. The physical action (recognized action ACT) performed from the activation of the registration mode until the predetermined entry time elapses is set as the registration action ACT-REG. It should be noted that the predetermined entry time is preferably set to be long to some extent in order to exclude the physical action that is too simple.

As another example, the user may enter an action completion code in the terminal device 200 after completing the physical action that the user wants to register. The action completion code is sent from the terminal device 200 to the secure element 100. The physical action (the recognized action ACT) performed from the activation of the registration mode to the entry of the action completion code is set as the registration action ACT-REG.

As still another example, the user may stop the movement for a first time or more after completing the physical action that the user wants to register. When the recognition of the physical action is suspended for a first time or more after the physical action is recognized, the physical action (the recognized action ACT) performed so far is set as the registration action ACT-REG.

As still another example, the user may be requested to repeat a physical action that the user wants to register N times (N is an integer of 2 or more). The request is notified to the user from the processor 130 through the terminal device 200, for example. The user performs a physical action that the user wants to register N times or more. When the same physical action is repeatedly recognized N times, the physical action (the recognized action ACT) is set as the registration action ACT-REG.

As still another example, the processor 130 may check whether or not the recognized physical action (the recognized action ACT) satisfies a predetermined condition. An example of the predetermined condition is that the physical action continues for a certain period of time or longer. Another example of the predetermined condition is that the physical action includes a combination of a gesture and a tap. When the recognized physical action (the recognized action ACT) does not satisfy the predetermined condition, the user may be requested to redo the physical action so as to satisfy the predetermined condition. The request is notified to the user from the processor 130 through the terminal device 200, for example. For example, if the physical action performed first is too simple (e.g., just shaking the secure element 100 once), the user is required to redo. The user changes the physical action to be registered to a more complex one.

In Step S40, the processor 130 stores the registration action information 160 indicating the content of the registration action ACT-REG in the memory 140. In particular, the processor 130 preferably stores the registration action information 160 in the secure area 145 of the memory 140.

### 4-2. User Authentication Process

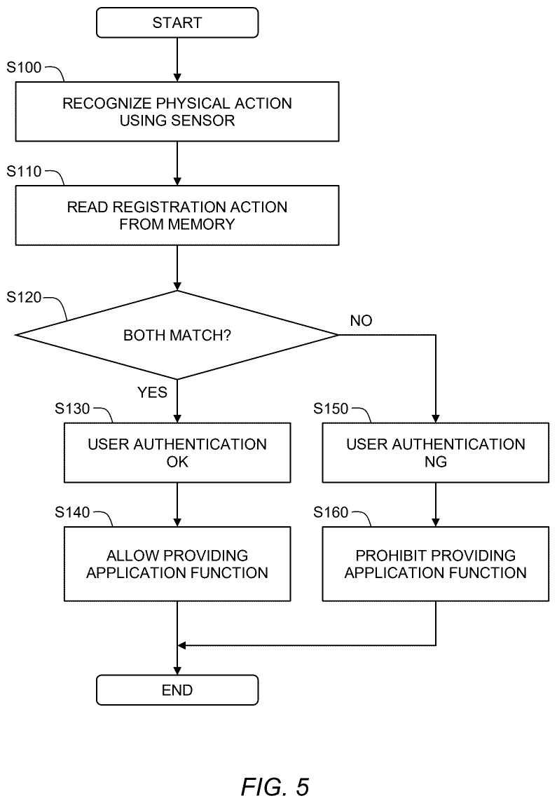

FIG. 5 is a flowchart illustrating a user authentication process. The user performs a physical action for the user authentication. That is, the user gives a physical action to the secure element 100. There is a possibility that a physical action similar to the physical action for the user authentication happens to be performed. In order to prevent misrecognition, it is preferable that the user repeats the physical action for a while. The user may repeat the physical action a few times. The user may be explicitly requested to repeat the physical action N times (N is an integer equal to or greater than 2). The request is notified to the user from the processor 130 through the terminal device 200, for example.

In Step S100, the processor 130 recognizes a physical action by using the sensor 170. More specifically, the processor 130 receives a result of detection by the sensor 170. Then, the processor 130 recognizes the physical action given to the secure element 100 on the basis of the result of detection by the sensor 170. The recognized physical action is the recognized action ACT. If the same physical action is repeatedly recognized N times, the physical action may be accepted as the recognized action ACT.

In Step S110, the processor 130 reads the registration action information 160 from the memory 140. Further, the processor 130 grasps the content of the registration action ACT-REG indicated by the registration action information 160. It should be noted that the order of the Step S100 and the Step S110 may be reversed.

In Step S120, the processor 130 compares the recognized action ACT with the registration action ACT-REG to determine whether the recognized action ACT matches the registration action ACT-REG.

When the recognized action ACT matches the registration action ACT-REG (Step S120; Yes), the processor 130 determines that the user authentication result is “OK” (Step S130). Then, the processor 130 permits providing the user with the function of the application 150 (Step S140).

On the other hand, when the recognized action ACT does not match the registration action ACT-REG, the processor 130 determines that the user authentication result is “NG” (Step S150). Then, the processor 130 prohibits providing the user with the function of the application 150 (Step S160).

As described above, according to the present embodiment, the user authentication is performed based on the physical action given to the secure element 100. That is, it is possible to perform the user authentication without using the terminal device 200 other than the secure element 100. In other words, it is possible to perform the user authentication without depending on security of the terminal device 200 other than the secure element 100. Furthermore, an attacker is unable to access the information of the registration action ACT-REG registered in the secure element 100. Therefore, the user authentication with high security is realized.

### 5. Other Examples

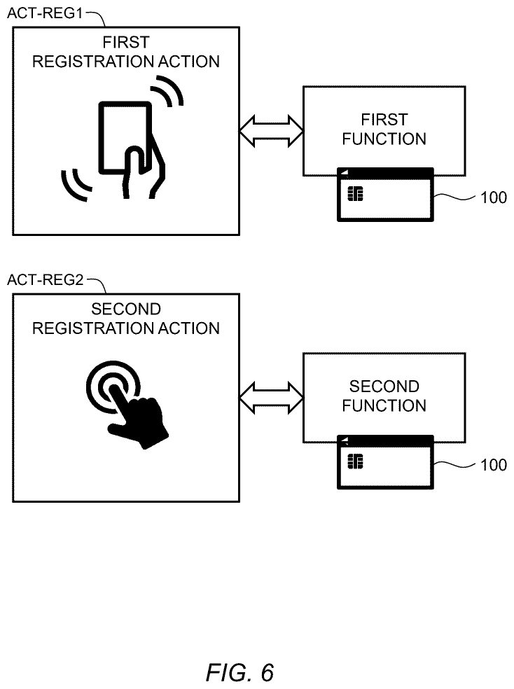

FIG. 6 is a conceptual diagram for explaining a modification example. The application 150 may provide a plurality of functions. In this case, different registration actions ACT-REG may be set for each function.

For example, the application 150 provides a first function and a second function. The registration actions ACT-REG include a first registration action ACT-REG1 associated with the first function and a second registration action ACT-REG2 associated with the second function.

When the recognized action ACT matches the first registration action ACT-REG1, the processor 130 allows providing the user with the first function of the application 150. On the other hand, when the recognized action ACT does not match the first registration action ACT-REG1, the processor 130 prohibits providing the user with the first function of the application 150.

Similarly, when the recognized action ACT matches the second registration action ACT-REG2, the processor 130 allows providing the user with the second function of the application 150. On the other hand, when the recognized action ACT does not match the second registration action ACT-REG2, the processor 130 prohibits providing the user with the second function of the application 150.

As another example, the action-based user authentication according to the present embodiment and general user authentication using a PIN can be combined.

What is claimed is:

1. A secure element with an application installed,
the secure element comprising:
a processor configured to execute the application;
a memory configured to store registration action information indicating a content of a registration action associated with a user of the secure element; and
a sensor configured to detect a change in the secure element caused by a physical action given to the secure element, wherein the processor is further configured to:
recognize a physical action given to the secure element based on a result of detection by the sensor;
when the recognized physical action matches the registration action, allow providing the user with a function of the application; and
when the recognized physical action does not match the registration action, prohibit providing the user with the function of the application.

2. The secure element according to claim 1, wherein
the registration action includes a first registration action associated with a first function of the application and a second registration action associated with a second function of the application,
the processor is further configured to:
when the recognized physical action matches the first registration action, allow providing the user with the first function of the application;
when the recognized physical action does not match the first registration action, prohibit providing the user with the first function of the application;
when the recognized physical action matches the second registration action, allow providing the user with the second function of the application;
when the recognized physical action does not match the second registration action, prohibit providing the user with the second function of the application.

3. The secure element according to claim 1, wherein
in a registration mode in which the user registers the registration action, the processor is configured to:
recognize a physical action given to the secure element based on a result of detection by the sensor; and
set the recognized physical action as the registration action and store the registration action information in the memory.

4. The secure element according to claim 1, wherein
the physical action is a gesture of the user with the secure element.

5. A user authentication method executed by a secure element with an application installed, wherein the secure element comprises: a memory configured to store registration action information indicating a content of a registration action associated with a user of the secure element; and a sensor configured to detect a change in the secure element caused by a physical action given to the secure element,
the user authentication method comprising:
recognizing a physical action given to the secure element based on a result of detection by the sensor;
when the recognized physical action matches the registration action, allowing providing the user with a function of the application; and
when the recognized physical action does not match the registration action, prohibiting providing the user with the function of the application.
